(19) United States
(12) Patent Application Publication
(10) Pub. No.: US 2013/0066674 A1
(43) Pub. Date: Mar. 14, 2013

(54) MARKETPLACE FOR TIMELY EVENT DATA DISTRIBUTION

(71) Applicant: Clemens Friedrich Vasters, Kirkland, WA (US)

(72) Inventor: Clemens Friedrich Vasters, Kirkland, WA (US)

(73) Assignee: Microsoft Corporation, Redmond, WA (US)

(21) Appl. No.: 13/278,418

(22) Filed: Oct. 21, 2011

Related U.S. Application Data
(60) Provisional application No. 61/533,671, filed on Sep. 12, 2011.
(60) Provisional application No. 61/533,669, filed on Sep. 12, 2011.

(51) Int. Cl. G06Q 30/02; G06F 15/16

(52) U.S. Cl. 705/7.29; 705/400; 709/219

(57) ABSTRACT

Delivering data. A method includes determining a relative monetary value of data, with respect to time, at a particular point in time. The method further includes based on the determined monetary value providing the data to a set of one or more end user consumer devices for consumers correlated to the monetary value.

### CROSS-REFERENCE TO RELATED APPLICATIONS

This application claims the benefit of U.S. Provisional application 61/533,671 filed Sep. 12, 2011, titled “MARKETPLACE FOR TIMELY EVENT DATA DISTRIBUTION” and U.S. Provisional application 61/533,669 filed Sep. 12, 2011, titled “SYSTEM TO DISTRIBUTE MOBILE PUSH NOTIFICATIONS SOURCED FROM A VARIETY OF EVENT SOURCES TARGETS WITH CUSTOMIZED MAPPING OF EVENT DATA TO NOTIFICATIONS” which are incorporated herein by reference in their entirety.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Many computers are intended to be used by direct user interaction with the computer. As such, computers have input hardware and software user interfaces to facilitate user interaction. For example, a modern general purpose computer may include a keyboard, mouse, touchpad, camera, etc for allowing a user to input data into the computer. In addition, various software user interfaces may be available.

Examples of software user interfaces include graphical user interfaces, text command line based user interface, function key or hot key user interfaces, and the like.

Internet connected applications are providing increasing end-user value by leveraging and interrelating data sets. Providers of geographic data, for instance, derive and have for a long time derived significant revenues from providing accurate information for maps and navigation. For applications, especially also in the mobile space, the user-value depth mostly corresponds directly to how much and how accurate the data is that the applications can rely on. A navigation application will, for instance, benefit greatly to leverage not only geographic data, but to be also able to tap information about hotels, restaurants, and gas stations, about supermarkets and malls and their opening hours, traffic information, weather warnings, and everything that could be of interest to someone on the move. As access to structured data becomes increasingly important for app competitiveness and user-value depth, there are increasing market opportunities for providers, owners, and generators of data to resell data they have for such purposes and there is an increasing opportunity for infrastructure providers to provide marketplace infrastructures that allow providers to sell and distribute such data.

At the same time, providers of real-time and near-real-time data have long derived significant revenues from providing access to ‘fresh’ data that is particularly valuable while it represents a current or very recent observable fact. Examples are financial market data, current business and world news, or sports results. Financial market pricing data, for instance, is most valuable within a few seconds or even milliseconds of the price having been set. It loses almost all of its value after 15 minutes and then regains some value as it becomes historical data used for charting and other analysis purposes.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method practiced in a computing system. The method includes acts for delivering data. The method includes determining a relative monetary value of data, with respect to time, at a particular point in time. The method further includes based on the determined monetary value providing the data to a set of one or more end user consumer devices for consumers correlated to the monetary value.

Another embodiment illustrated herein is directed to a method practiced in a computing system. The method includes acts for delivering data. The method includes determining a consumer tier for a consumers of data. The method further includes aging data before providing the data to end user devices correlated to the consumer tier to match the consumer tier.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a graph of the value of data over time;

FIG. 2 illustrates an event data market environment;

FIG. 3 illustrates an alternate depiction of an event data market environment;

FIG. 4 illustrates an alternate depiction of an event data market environment;

FIG. 5 illustrates an alternate depiction of an event data market environment;

FIG. 6 illustrates an event data acquisition and distribution system;

FIG. 7 illustrates an example of an event data acquisition system;

FIG. 8 illustrates an example of an event data distribution system;

FIG. 9 illustrates an event data acquisition and distribution system;

FIG. 10 illustrates a method of delivering data; and

FIG. 11 illustrates another method of delivering data.

### DETAILED DESCRIPTION

Some data may derive value based on, and a result of its ‘freshness’. For example, financial data, such as stock quotes, may have value that drops very rapidly as time progresses. At the same time, if the data can be provided very quickly, such as within a few milliseconds, the data may have very high value. Thus, fresh data may be in high-demand and can be provided in a fashion similar to how data available from queryable data repositories and/or data marketplaces provide data.

Some embodiments described herein may implement a marketplace for event data. Some embodiments may provide a platform and data distribution marketplace system for real-time data. Some embodiments may include an efficient multicast event delivery system so as to reduce delivery time and to keep the data more valuable by providing it in a fresher state. Some embodiments may allow for delivery into push notification systems. Some embodiments may include mechanisms for statistics and distribution tracking data collection for billing and/or bill-on-behalf scenarios. Further, some embodiments may include delivery service level agreement (SLA) tiering.

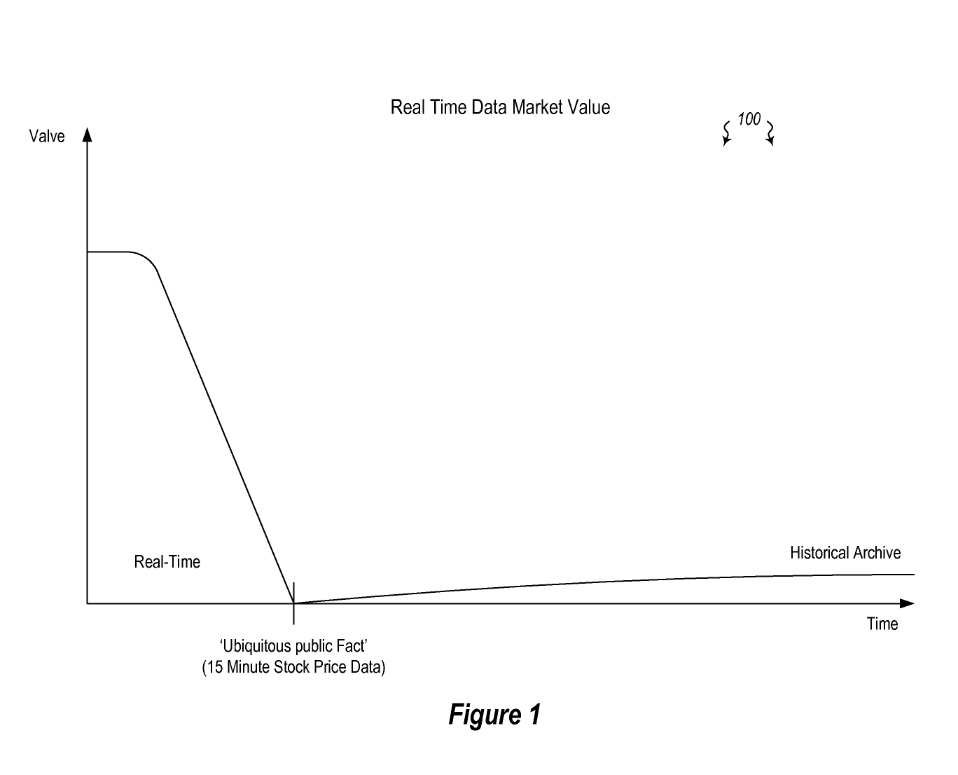

FIG. 1 illustrates a graph 100 illustrating the value of data over time. As illustrated, when real time data describing a present fact is first created, the data may have significant value. The value drops off quickly over time to a point where the data is at or near zero. The data then regains some value over time as it has value as a historical fact that can be archived and searched later. Thus, there is value in being able to provide current data to end users as quickly as possible.

One way of providing data quickly is through an event notification system, and in particular using an efficient event notification system as described in more detail below. In this way, data can be provided to users as quickly as the event notification system is able to get the data to the end users. Thus, if a user can be instantly notified and provided present fact data, the value of the data can be maintained. This would further allow the ability to recover higher compensation (either from a data provider or from a data consumer) for providing the data.

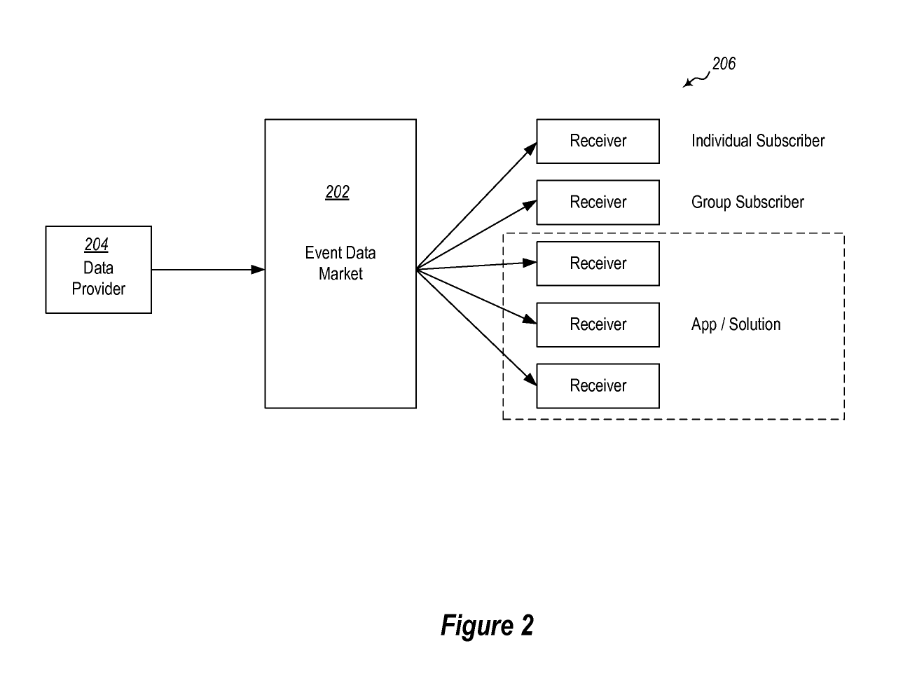

FIG. 2 illustrates an example of a data market 202 that may use an event distribution system to provide data. FIG. 2 illustrates that a data provider 204 that can provide data to an event data market 202. The data provider 204 may be any of a number of different sources, such as but not limited to, financial data providers, sports information data providers, news information providers, etc. The event data market 202 may be a data broker that receives data from a number of different sources and distributes the data to end consumers (shown as receivers 206).

FIG. 2 illustrates three groups of receivers, including individual subscribers to data, group subscribers to data, and subscribers who receive information as a result of having a particular application or solution deployed on an end user device. Other subscriber groups, though not shown specifically, may additionally or alternatively be implemented.

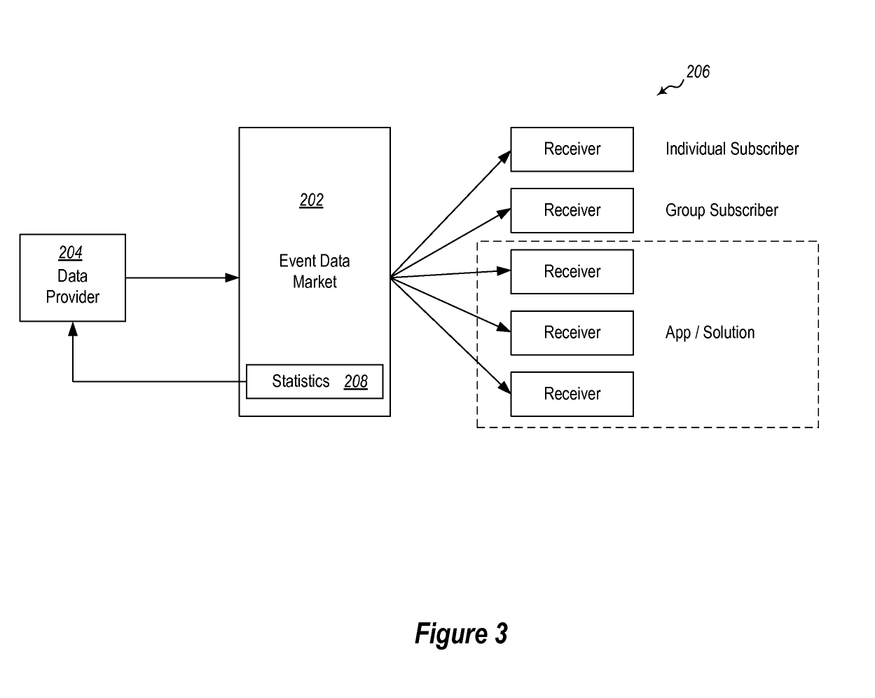

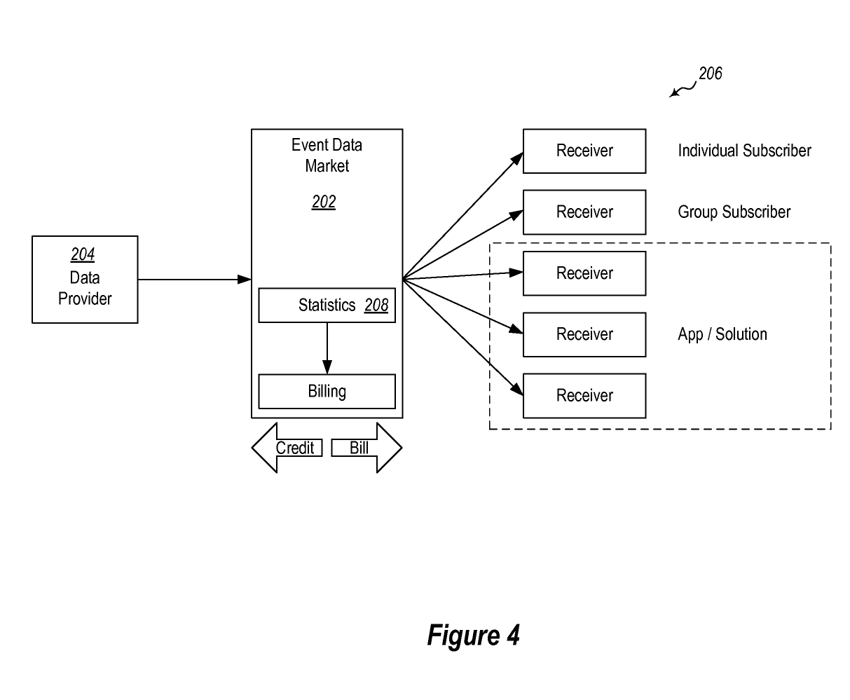

Compensation for data delivery may be structured in a number of different ways. FIGS. 3 and 4 illustrate two examples of how monetizing data delivery might be accomplished.

In a first example illustrated in FIG. 3, data delivery is billed to a data provider 204. The event data market 202 can provide statistics 208 regarding data delivery to the data provider 204, and the data provider 204 can bill receivers 206 of the data independently.

In a second example illustrated in FIG. 4, the data market 202 can bill receivers 206 directly. The data market 202 can then take their share, and pass on any additional funds to the data provider.

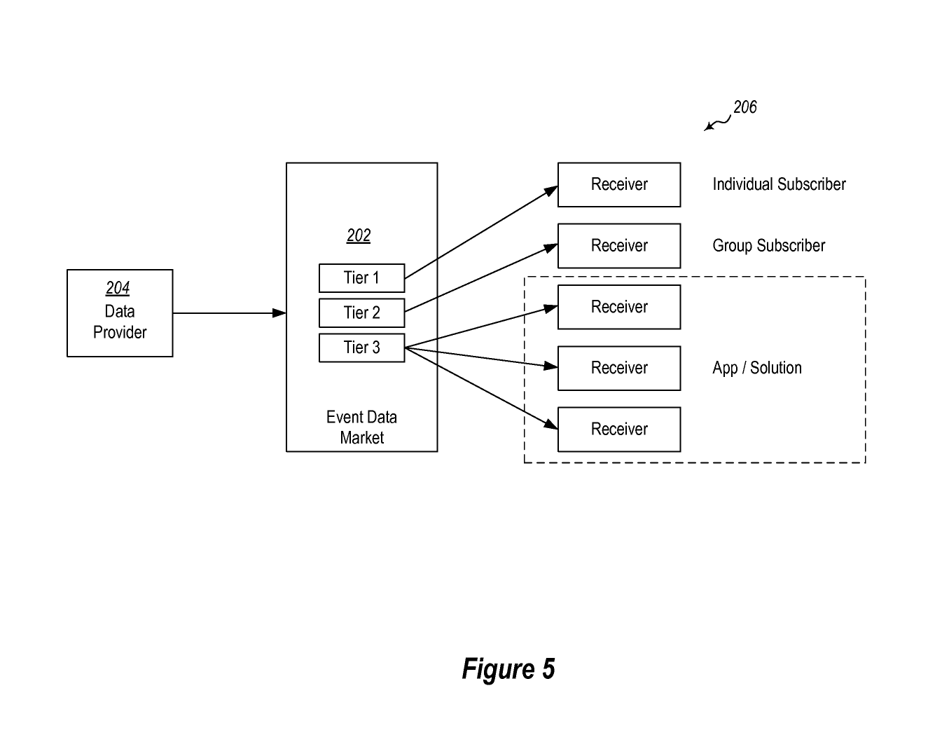

With reference now to FIG. 5, as noted previously, data may be more valuable the more quickly it can be delivered. Thus, some embodiments may provide data based on an amount paid by a subscriber (such as a receiver) or a data provider 204. For example, subscribers who pay more money for data may have their data delivered using an infrastructure designed or optimized to deliver data at a faster rate than some other infrastructure used to deliver data to subscribers who pay less money for their data. This may include using infrastructure components (such as servers) that are closer to subscribers allowing data to be delivered faster.

Alternatively or additionally, data may be gated at the data provider 204 where the gating allows the data to be delivered with a variable delay. For example, premium subscribers may be able to receive real-time data with little or no delay from when the data is generated to when the data is delivered, whereas data may be intentionally delayed for other subscribers, where the delay is dependent on a level of service that the subscriber has subscribed to. For example, in some embodiments, data providers may offer a limited number of premium service agreements guaranteeing delivery of real time data in a very short amount of time. By nature of the exclusivity and scarcity of these agreements, the data provider can potentially charge a large premium for these agreements. A second level of limited agreements may be provided for a lower premium. Real time data would be delayed from what the premium service subscribers are provided. Various levels could be provided, including levels of providing the data for free after a sufficiently long introduced delay.

The following now illustrates an example of a particularly efficient event system for providing real-time event data.

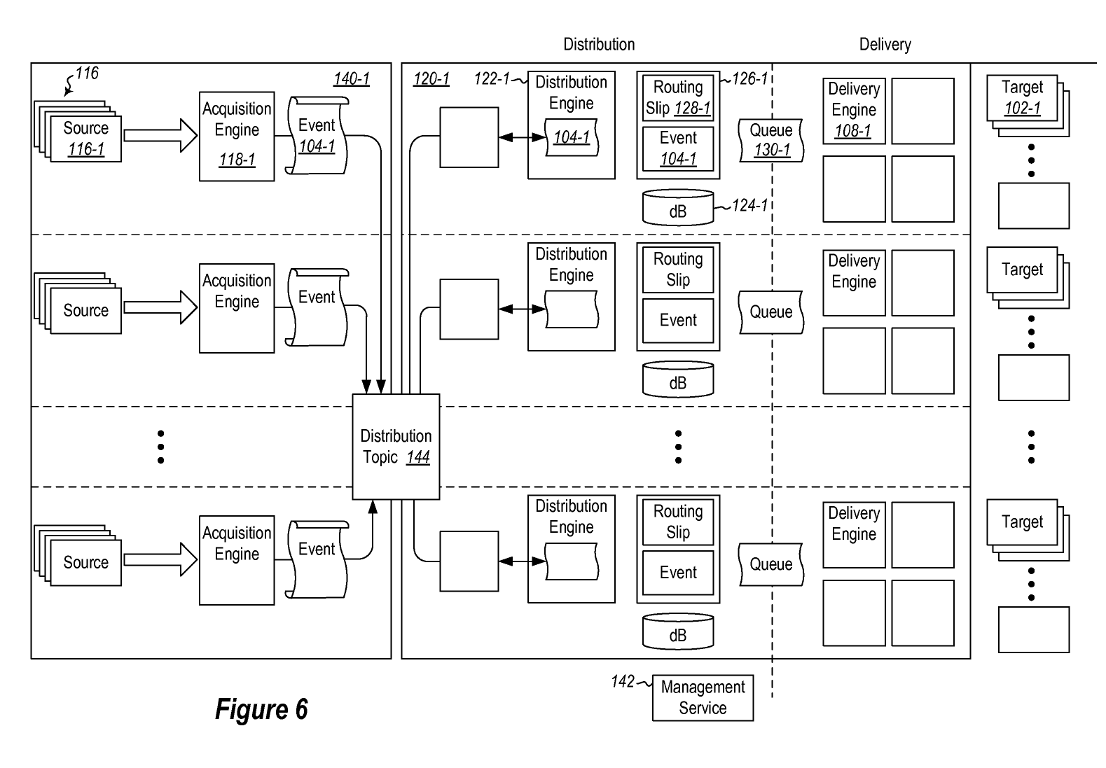

Such an example is illustrated in FIG. 6. FIG. 6 illustrates an example where information from a large number of different sources is delivered to a large number of different targets. In some examples, information from a single source, or information aggregated from multiple sources, may be used to create a single event that is delivered to a large number of the targets. This may be accomplished, in some embodiments, using a fan-out topology as illustrated in FIG. 6.

FIG. 6 illustrates sources 116. As will be discussed later herein, embodiments may utilize acquisition partitions 140. Each of the acquisition partitions 140 may include a number of sources 116. There may be potentially a large number and a diversity of sources 116. The sources 116 provide information. Such information may include, for example but not limited to, email, text messages, real-time stock quotes, real-time sports scores, news updates, etc.

FIG. 6 illustrates that each partition includes an acquisition engine, such as the illustrative acquisition engine 118. The acquisition engine 118 collects information from the sources 116, and based on the information, generates events. In the example illustrated in FIG. 6, a number of events are illustrated as being generated by acquisition engines using various sources. An event 104-1 is used for illustration. In some embodiments, the event 104-1 may be normalized as explained further herein. The acquisition engine 118 may be a service on a network, such as the Internet, that collects information from sources 116 on the network.

FIG. 6 illustrates that the event 104-1 is sent to a distribution topic 144. The distribution topic 144 fans out the events to a number of distribution partitions. Distribution partition 120-1 is used as an analog for all of the distribution partitions. The distribution partitions each service a number of end users or devices represented by subscriptions. The number of subscriptions serviced by a distribution partition may vary from that of other distribution partitions. In some embodiments, the number of subscriptions serviced by a partition may be dependent on the capacity of the distribution partition. Alternatively or additionally, a distribution partition may be selected to service users based on logical or geographical proximity to end users. This may allow alerts to be delivered to end users in a more timely fashion.

In the illustrated example, distribution partition 120-1 includes a distribution engine 122-1. The distribution engine 122-1 consults a database 124-1. The database 124-1 includes information about subscriptions with details about the associated delivery targets 102. In particular, the database may include information such as information describing platforms for the targets 102, applications used by the targets 102, network addresses for the targets 102, user preferences of end users using the targets 102, etc. Using the information in the database 124-1, the distribution engine 122-1 constructs a bundle 126-1, where the bundle 126-1 includes the event 104 (or at least information from the event 104) and a routing slip 128-1 identifying a plurality of targets 102 from among the targets 102 to which information from the event 104-1 will be sent as a notification. The bundle 126-1 is then placed in a queue 130-1.

The distribution partition 120-1 may include a number of delivery engines. The delivery engines dequeue bundles from the queue 103-1 and deliver notifications to targets 102. For example, a delivery engine 108-1 can take the bundle 126-1 from the queue 13-1 and send the event 104 information to the targets 102 identified in the routing slip 128-1. Thus, notifications 134 including event 104-1 information can be sent from the various distribution partitions to targets 102 in a number of different formats appropriate for the different targets 102 and specific to individual targets 102. This allows individualized notifications 134, individualized for individual targets 102, to be created from a common event 104-1 at the edge of a delivery system rather than carrying large numbers of individualized notifications through the delivery system.

The following illustrates alternative descriptions of information collection and event distribution systems that may be used in some embodiments.

As a foundation, one embodiment system is using a publish/subscribe infrastructure as provided by Windows Azure Service Bus available from Microsoft Corporation of Redmond Wash., but which also exists in similar form in various other messaging systems. The infrastructure provides two capabilities that facilitate the described implementation of the presented method: Topics and Queues.

A Queue is a storage structure for messages that allows messages to be added (enqueued) in sequential order and to be removed (dequeued) in the same order as they have been added. Messages can be added and removed by any number of concurrent clients, allowing for leveling of load on the enqueue side and balancing of processing load across receivers on the dequeue side. The queue also allows entities to obtain a lock on a message as it is dequeued, allowing the consuming client explicit control over when the message is actually deleted from the queue or whether it may be restored into the queue in case the processing of the retrieved message fails.

A Topic is a storage structure that has all the characteristics of a Queue, but allows for multiple, concurrently existing ‘subscriptions’ which each allow an isolated, filtered view over the sequence of enqueued messages. Each subscription on a Topic yields a copy of each enqueued message provided that the subscription's associated filter condition(s) positively match the message. As a result, a message enqueued into a Topic with 10 subscriptions where each subscription has a simple ‘passthrough’ condition matching all messages, will yield a total of 10 messages, one for each subscription. A subscription can, like a Queue, have multiple concurrent consumers providing balancing of processing load across receivers.

Another foundational concept is that of ‘event’, which is, in terms of the underlying publish/subscribe infrastructure just a message. In the context of one embodiment, the event is subject to a set of simple constraints governing the use of the message body and message properties. The message body of an event generally flows as an opaque data block and any event data considered by one embodiment generally flows in message properties, which is a set of key/value pairs that is part of the message representing the event.

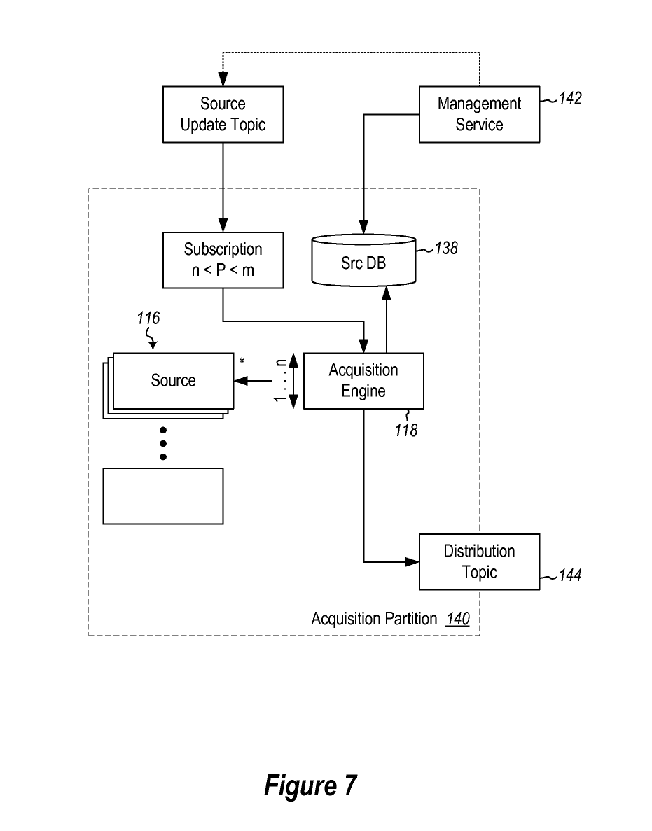

Referring now to FIG. 7, one embodiment architecture's goal is to acquire event data from a broad variety of different sources 116 at large scale and forward these events into a publish/subscribe infrastructure for further processing. The processing may include some form of analysis, real time search, or redistribution of events to interested subscribers through pull or push notification mechanisms.

One embodiment architecture defines an acquisition engine 118, a model for acquisition adapters and event normalization, a partitioned store 138 for holding metadata about acquisition sources 116, a common partitioning and scheduling model, and a model for how to flow user-initiated changes of the state of acquisition sources 116 into the system at runtime and without requiring further database lookups.

In a concrete implementation, the acquisition may support concrete acquisition adapters to source events from a broad variety of public and private networked services, including RSS, Atom, and OData feeds, email mailboxes including but not limited to such supporting the IMAP and POP3 protocols, social network information sources 116 like Twitter timelines or Facebook walls, and subscriptions on external publish/subscribe infrastructures like Windows Azure Service Bus or Amazon's Simple Queue Service.

### Event Normalization

Event data is normalized to make events practically consumable by subscribers on a publish/subscribe infrastructure that they are being handed off to. Normalization means, in this context, that the events are mapped onto a common event model with a consistent representation of information items that may be of interest to a broad set of subscribers in a variety of contexts. The chosen model here is a simple representation of an event in form of a flat list of key/value pairs that can be accompanied by a single, opaque, binary chunk of data not further interpreted by the system. This representation of an event is easily representable on most publish/subscribe infrastructures and also maps very cleanly to common Internet protocols such as HTTP.

To illustrate the event normalization, consider the mapping of an RSS or Atom feed entry into an event 104 (see FIGS. 1 and 2). RSS and Atom are two Internet standards that are very broadly used to publish news and other current information, often in chronological order, and that aids in making that information available for processing in computer programs in a structured fashion. RSS and Atom share a very similar structure and a set of differently named but semantically identical data elements. So a first normalization step is to define common names as keys for such semantically identical elements that are defined in both standards, like a title or a synopsis. Secondly, data that only occurs in one but not in the other standard is usually mapped with the respective ‘native’ name. Beyond that, these kinds of feeds often carry ‘extensions’, which are data items that are not defined in the core standard, but are using extensibility facilities in the respective standards to add additional data.

Some of these extensions, including but not limited to GeoRSS for geolocation or OData for embedding structured data into Atom feeds are mapped in a common way that is shared across different event sources 116, so that the subscriber on the publish/subscribe infrastructure that the events are emitted to can interpret geolocation information in a uniform fashion irrespective of whether the data has been acquired from RSS or Atom or a Twitter timeline. Continuing with the GeoRSS example, a simple GeoRSS expression representing a geography ‘point’ can thus be mapped to a pair of numeric ‘Latitude’/‘Longitude’ properties representing WGS84 coordinates.

Extensions that carry complex, structured data such as OData may implement a mapping model that preserves the complex type structure and data without complicating the foundational event model. Some embodiments normalize to a canonical and compact complex data representation like JSON and map a complex data property, for instance an OData property ‘Tenant’ of a complex data type ‘Person’ to a key/value pair where the key is the property name ‘Tenant’ and the value is the complex data describing the person with name, biography information, and address information represented in a JSON serialized form. If the data source is an XML document, as it is in the case of RSS or Atom, the value may be created by transcribing the XML data into JSON preserving the structure provided by XML, but flattening out XML particularities like attributes and element, meaning that both XML attributes and elements that are subordinates of the same XML element node are mapped to JSON properties as ‘siblings’ with no further differentiation.

### Sources and Partitioning

One embodiment architecture captures metadata about data sources 116 in ‘source description’ records, which may be stored in the source database 138. A ‘source description’ may have a set of common elements and a set of elements specific to a data source. Common elements may include the source's name, a time span interval during which the source 116 is considered valid, a human readable description, and the type of the source 116 for differentiation. Source specific elements depend on the type of the source 116 and may include a network address, credentials or other security key material to gain access to the resource represented by the address, and metadata that instructs the source acquisition adapter to either perform the data acquisition in a particular manner, like providing a time interval for checking an RSS feed, or to perform forwarding of events in a particular manner, such as spacing events acquired from a current events news feed at least 60 seconds apart so that notification recipients get the chance to see each breaking news item on a constrained screen surface if that is the end-to-end experience to be constructed.

The source descriptions are held in one or multiple stores, such as the source database 138. The source descriptions may be partitioned across and within these stores along two different axes.

The first axis is a differentiation by the system tenant. System tenants or ‘namespaces’ are a mechanism to create isolated scopes for entities within a system. Illustrating a concrete case, if “Fred” is a user of a system implementing one embodiment, Fred will be able to create a tenant scope which provides Fred with an isolated, virtual environment that can hold source descriptions and configuration and state entirely independent of other sources 116 in the system. This axis may serve as a differentiation factor to spread source descriptions across stores, specifically also in cases where a tenant requires isolation of the stored metadata (which may include security sensitive data such as passwords), or for technical, regulatory or business reasons. A system tenant may also represent affinity to a particular datacenter in which the source description data is held and from where data acquisition is to be performed.

The second axis may be a differentiation by a numeric partition identifier chosen from a predefined identifier range. The partition identifier may be derived from invariants contained in the source description, such as for example, the source name and the tenant identifier. The partition identifier may be derived from these invariants using a hash function (one of many candidates is the Jenkins Hash, see http://www.burtleburtle.net/bob/hash/doobs.html) and the resulting hash value is computed down into the partition identifier range, possibly using a modulo function over the hash value. The identifier range is chosen to be larger (and can be substantially larger) than the largest number of storage partitions expected to be needed for storing all source descriptions to be ever held in the system.

Introducing storage partitions is commonly motivated by capacity limits, which are either immediately related to storage capacity quotas on the underlying data store or related to capacity limits affecting the acquisition engine 118 such as bandwidth constraints for a given datacenter or datacenter section, which may result in embodiments creating acquisition partitions 140 that are utilizing capacity across different datacenters or datacenter segments to satisfy the ingress bandwidth needs. A storage partition owns a subset of the overall identifier range and the association of a source description record with a storage partition (and the resources needed to access it) can be thus be directly inferred from its partition identifier.

Beyond providing a storage partitioning axis, the partition identifier is also used for scheduling or acquisition jobs and clearly defining the ownership relationship of an acquisition partition 140 to a given source description (which is potentially different from the relationship to the storage partition).

### Ownership and Acquisition Partitions

Each source description in the system may be owned by a specific acquisition partition 140. Clear and unique ownership is used because the system does not acquire events from the exact same source 116 in multiple places in parallel as this may cause duplicate events to be emitted. To make this more concrete, one RSS feed defined within the scope of a tenant is owned by exactly one acquisition partition 140 in the system and within the partition there is one scheduled acquisition run on the particular feed at any given point in time.

An acquisition partition 140 gains ownership of a source description by way of gaining ownership of a partition identifier range. The identifier range may be assigned to the acquisition partition 140 using an external and specialized partitioning system that may have failover capabilities and can assign master/backup owners, or using a simpler mechanism where the partition identifier range is evenly spread across the number of distinct compute instances assuming the acquisition engine role. In a more sophisticated implementation with an external partitioning system, the elected master owner for a partition is responsible for seeding the scheduling of jobs if the system starts from a ‘cold’ state, meaning that the partition has not had a previous owner. In the simpler scenario, the compute instance owning the partition owns seeding the scheduling.

### Scheduling

The scheduling needs for acquisition jobs depend on the nature of the concrete source, but there are generally two kinds of acquisition models that are realized in some described embodiments.

In a first model, the owner initiates some form of connection or long-running network request on the source's network service and waits for data to be returned on the connection in form of datagrams or a stream. In the case of a long-running request, commonly also referred to as long-polling, the source network service will hold on to the request until a timeout occurs or until data becomes available—in turn, the acquisition adapter will wait for the request to complete with or without a payload result and then reissue the request. As a result, this acquisition scheduling model has the form of a ‘tight’ loop that gets initiated as the owner of the source 116 learns about the source, and where a new request or connection is initiated immediately as the current connection or request completes or gets temporarily interrupted. As the owner is in immediate control of the tight loop, the loop can be reliably kept alive while the owner is running If the owner stops and restarts, the loop also restarts. If the ownership changes, the loop stops and the new owner starts the loop.

In a second model, the source's network service does not support long-running requests or connections yielding data as it becomes available, but are regular request/response services that return immediately whenever queried. On such services, and this applies to many web resources, requesting data in a continuous tight loop causes an enormous amount of load on the source 116 and also causes significant network traffic that either merely indicates that the source 116 has not changed, or that, in the worst case, carries the same data over and over again. To balance the needs of timely event acquisition and not overload the source 116 with fruitless query traffic, the acquisition engine 118 will therefore execute requests in a ‘timed’ loop, where requests on the source 116 are executed periodically based on an interval that balances those considerations and also takes hints from the source 116 into account. The ‘timed’ loop gets initiated as the owner of the source 116 learns about the source.

There are two noteworthy implementation variants for the timed loop. The first variant is for low-scale, best-effort scenarios and uses a local, in-memory timer objects for scheduling, which cause the scale, control and restart characteristics to be similar to those of a tight loop. The loop gets initiated and immediately schedules a timer callback causing the first iteration of the acquisition job to run. As that job completes (even with an error) and it is determined that the loop shall continue executing, another timer callback is scheduled for the instant at which the job shall be executed next.

The second variant uses ‘scheduled messages’, which is a feature of several publish/subscribe systems, including Windows Azure™ Service Bus. The variant provides significantly higher acquisition scale at the cost of somewhat higher complexity. The scheduling loop gets initiated by the owner and a message is placed into the acquisition partition's scheduling queue. The message contains the source description. It is subsequently picked up by a worker which performs the acquisition job and then enqueues the resulting event into the target publish/subscribe system. Lastly, it also enqueues a new ‘scheduled’ message into the scheduling queue. That message is called ‘scheduled’ since it is marked with a time instant at which it becomes available for retrieval by any consumer on the scheduling queue.

In this model, an acquisition partition 140 can be scaled out by having one ‘owner’ role that primarily seeds scheduling and that can be paired with any number of ‘worker’ roles that perform the actual acquisition jobs.

### Source Updates

As the system is running, the acquisition partitions 140 need to be able to learn about new sources 116 to observe and about which sources 116 shall no longer be observed. The decision about this typically lies with a user, except in the case of blacklisting a source 116 (as described below) due to a detected unrecoverable or temporary error, and is the result of an interaction with a management service 142. To communicate such changes, the acquisition system maintains a ‘source update’ topic in the underlying publish/subscribe infrastructure. Each acquisition partition 140 has a dedicated subscription on the topic with the subscription having a filter condition that constrains the eligible messages to those that carry a partition identifier within the acquisition partition's owned range. This enables the management service 142 to set updates about new or retired sources 116 and send them to the correct partition 140 without requiring knowledge of the partition ownership distribution.

The management service 142 submits update commands into the topic that contain the source description, the partition identifier (for the aforementioned filtering purpose), and an operation identifier which indicates whether the source 116 is to be added or whether the source 116 is removed from the system.

Once the acquisition partition 140 owner has retrieved a command message, it will either schedule a new acquisition loop for a new source 116 or it will interrupt and suspend or even retire the existing acquisition loop.

### Blacklisting

Sources 116 for which the data acquisition fails may be temporarily or permanently blacklisted. A temporary blacklisting is performed when the source 116 network resource is unavailable or returns an error that is not immediately related to the issued acquisition request. The duration of a temporary blacklisting depends on the nature of the error. Temporary blacklisting is performed by interrupting the regular scheduling loop (tight or timed) and scheduling the next iteration of the loop (by ways of callback or scheduled message) for a time instant when the error condition is expected to be resolved by the other party.

Permanent blacklisting is performed when the error is determined to be an immediate result of the acquisition request, meaning that the request is causing an authentication or authorization error or the remote source 116 indicates some other request error. If a resource is permanently blacklisted, the source 116 is marked as blacklisted in the partition store and the acquisition loop is immediately aborted. Reinstating a permanently blacklisted source 116 requires removing the blacklist marker in the store, presumably along with configuration changes that cause a behavior change for the request, and restarting the acquisition loop via the source update topic.

### Notification Distribution

Embodiments may be configured to distribute a copy of information from a given input event to each of a large number of ‘targets 102’ that are associated with a certain scope and do so in minimal time for each target 102. A target 102 may include an address of a device or application that is coupled to the identifier of an adapter to some 3rd party notification system or to some network accessible external infrastructure and auxiliary data to access that notification system or infrastructure.

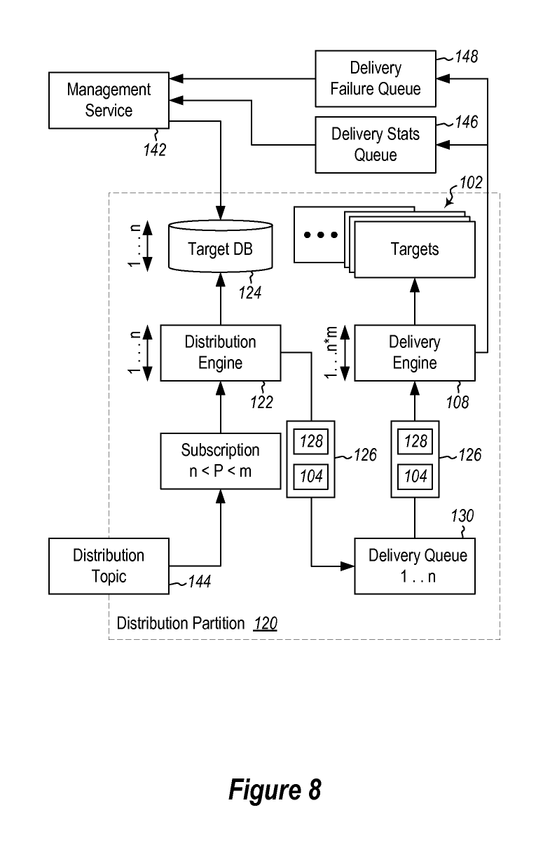

Some embodiments may include an architecture that is split up into three distinct processing roles, which are described in the following in detail and can be understood by reference to FIG. 8. As noted in FIG. 8 by the ‘1’, the ellipses, and ‘n’, each of the processing roles can have one or more instances of the processing role. Note that the use of ‘n’ in each case should be considered distinct from each other case as applied to the processing roles, meaning that each of the processing roles do not need to have the same number of instances. The ‘distribution engine’ 112 role accepts events and bundles them with routing slips (see e.g. routing slip 128-1 in FIG. 6) containing groups of targets 102. The ‘delivery engine’ 108 accepts these bundles and processes the routing slips for delivery to the network locations represented by the targets 102. The ‘management role’ illustrated by the management service 142 provides an external API to manage targets 102 and is also responsible for accepting statistics and error data from the delivery engine 108 and for processing/storing that data.

The data flow is anchored on a ‘distribution topic 144’ into which events are submitted for distribution. Submitted events are labeled, using a message property, with the scope they are associated with—which may be one of the aforementioned constraints that distinguish events and raw messages.

The distribution topic 144, in the illustrated example, has one passthrough (unfiltered) subscription per ‘distribution partition 120’. A ‘distribution partition’ is an isolated set of resources that is responsible for distributing and delivering notifications to a subset of the targets 102 for a given scope. A copy of each event sent into the distribution topic is available to all concurrently configured distribution partitions at effectively the same time through their associated subscriptions, enabling parallelization of the distribution work.

Parallelization through partitioning helps to achieve timely distribution. To understand this, consider a scope with 10 million targets 102. If the targets' data was held in an unpartitioned store, the system would have to traverse a single, large database result set in sequence or, if the results sets were acquired using partitioning queries on the same store, the throughput for acquiring the target data would at least be throttled by the throughput ceiling of the given store's fronting network gateway infrastructure, as a result, the delivery latency of the delivery of notifications to targets 102 whose description records occur very late in the given result sets will likely be dissatisfactory.

If, instead, the 10 million targets 102 are distributed across 1,000 stores that each hold 10,000 target records and those stores are paired with dedicated compute infrastructure (distribution engine 122′ and ‘delivery engine 108’ described herein) performing the queries and processing the results in form of partitions as described here, the acquisition of the target descriptions can be parallelized across a broad set of compute and network resources, significantly reducing the time difference for distribution of all events measured from the first to the last event distributed.

The actual number of distribution partitions is not technically limited. It can range from a single partition to any number of partitions greater than one.

In the illustrated example, once the ‘distribution engine 122’ for a distribution partition 120 acquires an event 104, it first computes the size of the event data and then computes the size of the routing slip 128, which may be calculated based on delta between the event size and the lesser of the allowable maximum message size of the underlying messaging system and an absolute size ceiling. Events are limited in size in such a way that there is some minimum headroom for ‘routing slip’ data.

The routing slip 128 is a list that contains target 102 descriptions. Routing slips are created by the distribution engine 122 by performing a lookup query matching the event's scope against the targets 102 held in the partition's store 124, returning all targets 102 matching the event's scope and a set of further conditions narrowing the selection based on filtering conditions on the event data. Embodiments may include amongst those filter conditions a time window condition that will limit the result to those targets 102 that are considered valid at the current instant, meaning that the current UTC time is within a start/end validity time window contained in the target description record. This facility is used for blacklisting, which is described later in this document. As the lookup result is traversed, the engine creates a copy of the event 104, fills the routing slip 128 up to the maximum size with target descriptions retrieved from the store 124, and then enqueues the resulting bundle of event and routing slip into the partition's ‘delivery queue 130’.

The routing slip technique ensures that the event flow velocity of events from the distribution engine 122 to the delivery engine(s) 108 is higher than the actual message flow rate on the underlying infrastructure, meaning that, for example, if 30 target descriptions can be packed into a routing slip 128 alongside the event data, the flow velocity of event/target pairs is 30 times higher than if the event/target pairs were immediately grouped into messages.

The delivery engine 108 is the consumer of the event/routing-slip bundles 126 from the delivery queue 130. The role of the delivery engine 108 is to dequeue these bundles, and deliver the event 104 to all destinations listed in the routing slip 128. The delivery commonly happens through an adapter that formats the event message into a notification message understood by the respective target infrastructure. For example, the notification message may be delivered in a MPNS format for Windows® 7 phone, APN (Apple Push Notification) formats for iOS devices, C2DM (Cloud To Device Messaging) formats for Android devices, JSON (Java Script Object Notation) formats for browsers on devices, HTTP (Hyper Text Tranfer Protocol), etc

The delivery engine 108 will commonly parallelize the delivery across independent targets 102 and serialize delivery to targets 102 that share a scope enforced by the target infrastructure. An example for the latter is that a particular adapter in the delivery engine may choose to send all events targeted at a particular target application on a particular notification platform through a single network connection.

The distribution and delivery engines 122 and 108 are decoupled using the delivery queue 130 to allow for independent scaling of the delivery engines 108 and to avoid having delivery slowdowns back up into and block the distribution query/packing stage.

Each distribution partition 120 may have any number of delivery engine instances that concurrently observe the delivery queue 130. The length of the delivery queue 130 can be used to determine how many delivery engines are concurrently active. If the queue length crosses a certain threshold, new delivery engine instances can be added to the partition 120 to increase the send throughput.

Distribution partitions 120 and the associated distribution and delivery engine instances can be scaled up in a virtually unlimited fashion in order to achieve optimal parallelization at high scale. If the target infrastructure is capable of receiving and forwarding one million event requests to devices in an in-parallel fashion, the described system is capable of distributing events across its delivery infrastructure—potentially leveraging network infrastructure and bandwidth across datacenters—in a way that it can saturate the target infrastructure with event submissions for a delivery to all desired targets 102 that is as timely as the target infrastructure will allow under load and given any granted delivery quotas.

As messages are delivered to the targets 102 via their respective infrastructure adapters, in some embodiments, the system takes note of a range of statistical information items. Amongst those are measured time periods for the duration between receiving the delivery bundle and delivery of any individual message and the duration of the actual send operation. Also part of the statistics information is an indicator on whether a delivery succeeded or failed. This information is collected inside the delivery engine 108 and rolled up into averages on a per-scope and on a per-target-application basis. The ‘target application’ is a grouping identifier introduced for the specific purpose of statistics rollup. The computed averages are sent into the delivery stats queue 146 in defined intervals. This queue is drained by a (set of) worker(s) in the management service 142, which submits the event data into a data warehouse for a range of purposes. These purposes may include, in addition to operational monitoring, billing of the tenant for which the events have been delivered and/or disclosure of the statistics to the tenant for their own billing of 3rd parties.

As delivery errors are detected, these errors are classified into temporary and permanent error conditions. Temporary error conditions may include, for example, network failures that do not permit the system to reach the target infrastructure's delivery point or the target infrastructure reporting that a delivery quota has been temporarily reached. Permanent error conditions may include, for example, authentication/authorization errors on the target infrastructure or other errors that cannot be healed without manual intervention and error conditions where the target infrastructure reports that the target is no longer available or willing to accept messages on a permanent basis. Once classified, the error report is submitted into the delivery failure queue 148. For temporary error conditions, the error may also include the absolute UTC timestamp until when the error condition is expected to be resolved. At the same time, the target is locally blacklisted by the target adapter for any further local deliveries by this delivery engine instance. The blacklist may also include the timestamp.

The delivery failure queue 148 is drained by a (set of) worker(s) in the management role. Permanent errors may cause the respective target to be immediately deleted from its respective distribution partition store 124 to which the management role has access. ‘Deleting’ may mean that the record is indeed removed or alternatively that the record is merely moved out of sight of the lookup queries by setting the ‘end’ timestamp of its validity period to the timestamp of the error. Temporary error conditions may cause the target to be deactivated for the period indicated by the error. Deactivation may be done by moving the start of the target's validity period up to the timestamp indicated in the error at which the error condition is expected to be healed.

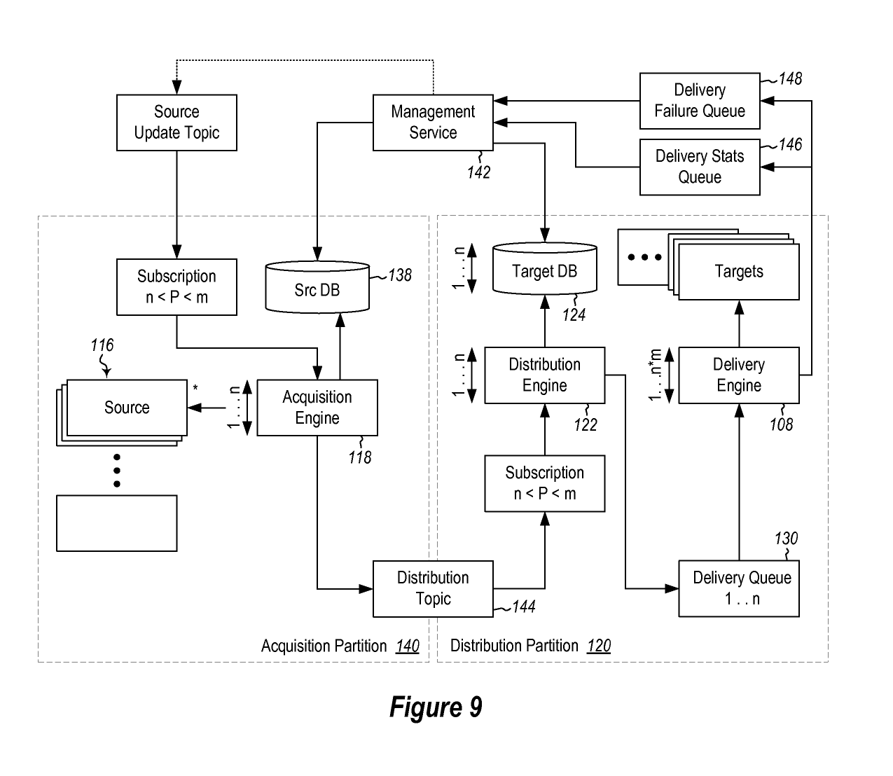

FIG. 9 illustrates a system overview illustration where an acquisition partition 140 is coupled to a distribution partition 120 through a distribution topic 144.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

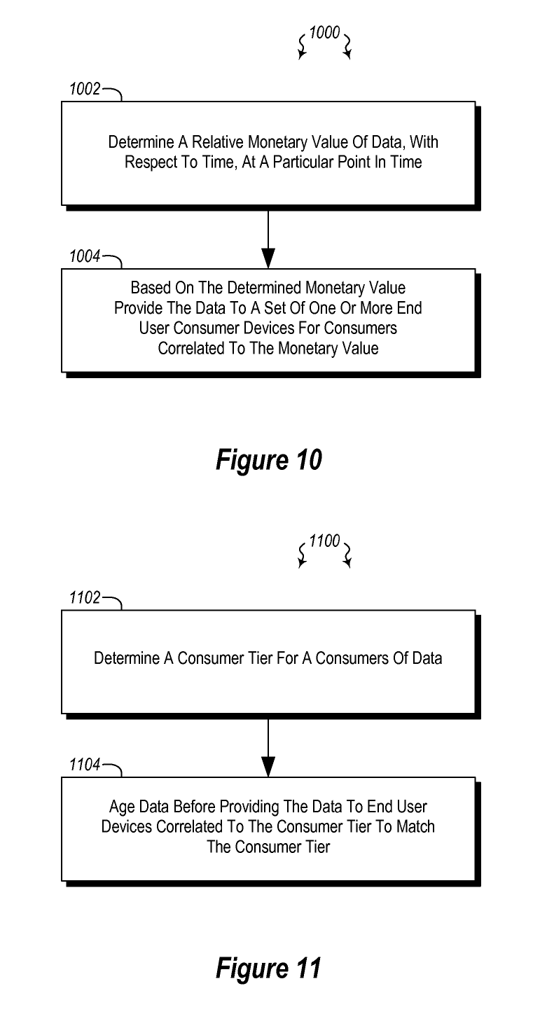

FIG. 10 illustrates a method 1000. The method 1000 may be practiced in a computing system. The method 1000 includes acts for delivering data. The method includes determining a relative monetary value of data, with respect to time, at a particular point in time (act 1002). Data can be determined as a function of time. For example, with reference to FIG. 1, data has its highest value at time t=0, and its lowest value at t=15 minutes. Thus, at a particular time, data has a particular value. For a particular point in time, this value could be determined.

The method 1000 further includes based on the determined monetary value providing the data to a set of one or more end user consumer devices for consumers correlated to the monetary value (act 1004). For example, some consumers may pay a premium for data, and thus delivery of the data will be attempted as close to time t=0 as possible. Other consumers may pay less for data, and therefore, the data will be attempted to be delivered at some time after t=0 that corresponds to a level for those consumers paying less.

The method 1000 may be practiced where providing the data to a set of one or more end user consumer devices for consumers correlated to the monetary value comprises providing data to end user consumer devices according to a service level agreements with end users.

The method 1000 may be practiced where providing the data to a set of one or more end user consumer devices for consumers correlated to the monetary value comprises providing data to different end user consumer devices according different tiering levels. For example, FIG. 5 illustrates how different tiers of data freshness can be used to provide data to consumers through their consumer devices.

The method 1000 may be practiced where providing the data to a set of one or more end user consumer devices for consumers correlated to the monetary value comprises gating the data to intentionally delay delivery of the data. For example, data may be intentionally delayed to decrease its value based on a level of service or a preference level of a consumer.

The method 1000 may be practiced where providing the data to a set of one or more end user consumer devices for consumers correlated to the monetary value comprises providing data to an end user consumer device based on an amount paid by a subscriber. For example, some consumers may receive fresher data based on having paid an amount of money. Similarly, higher payments may result in fresher data being delivered to a consumer device.

The method 1000 may be practiced where providing the data to a set of one or more end user consumer devices for consumers correlated to the monetary value comprises providing data by selecting an infrastructure from among a plurality of infrastructures to deliver the data to one or more end user consumer devices, wherein selecting an infrastructure is performed to select a preferred infrastructure for preferred subscribers. For example, some infrastructures may be preferred over other infrastructures in that the preferred infrastructures have features that allow for data to be delivered through them more quickly than other infrastructures. Thus, higher tiered or higher preferred subscribers, as compared to lower tiered or lower preferred subscribers, may receive data though preferred infrastructures as opposed to receiving the data over other infrastructures.

The method 1000 may further include providing statistics about how data was provided to end user consumer devices to a data provider. For example, as illustrated in FIG. 3, statistics 208 can be provided to the data provider 204. This may allow the data provider to bill subscribers for data according to how the data was provided to them.

Referring now to FIG. 11, another method 1100 is illustrated. The method 1100 may be practiced in a computing system. The method 1100 includes acts for delivering data. The method 1100 includes determining a consumer tier for a consumer of data (act 1102). For example, FIG. 5 illustrates different tiering for different consumers. The method 1100 further includes aging data before providing the data to end user devices correlated to the consumer tier to match the consumer tier (act 1104). For example, data may be intentionally not sent to consumers until it has been sufficiently delayed to match a consumer tier. This can be understood with reference to FIG. 1 which shows data deteriorating in value over time. Thus consumers in a lower tier may receive lower value data that has been made lower valued by delaying its delivery. Similarly, methods may include intentionally degrading the quality of the data itself external to degraded data as being stale, for delivery to lower tier consumers.

The method 1100 may be practiced where aging data comprises aging data for end user consumer devices according to service level agreements with end users.

The method 1100 may be practiced where aging data comprises aging data for different end user consumer devices according different tiering levels. For example, FIG. 5 illustrates how different tiers of data freshness can be used to provide data to consumers through their consumer devices.

The method 1100 may be practiced where aging data comprises gating the data to intentionally delay delivery of the data. For example, data may be intentionally delayed to decrease its value based on a level of service or a preference level of a consumer.

The method 1100 may be practiced where aging data comprises aging data for an end user consumer device based on an amount paid by a subscriber. For example, some consumers may receive fresher data based on having paid an amount of money. Similarly, higher payments may result in fresher data being delivered to a consumer device.

The method 1100 may be practiced where aging data comprises selecting an infrastructure from among a plurality of infrastructures to deliver the data to one or more end user consumer devices, wherein selecting an infrastructure is performed to select a preferred infrastructure for preferred subscribers and a less preferred infrastructure for less preferred subscribers. For example, some infrastructures may be preferred over other infrastructures in that the preferred infrastructures have features that allow for data to be delivered through them more quickly than other infrastructures. Thus, higher tiered or higher preferred subscribers, as compared to lower tiered or lower preferred subscribers, may receive data though preferred infrastructures as opposed to receiving the data over other infrastructures.

The method 100 may further include providing statistics about how data was provided to end user consumer devices to a data provider. For example, as illustrated in FIG. 3, statistics 208 can be provided to the data provider 204. This may allow the data provider to bill subscribers for data according to how the data was provided to them.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system, a method of delivering data, the method comprising:
determining a relative monetary value of data, with respect to time, at a particular point in time; and
based on the determined monetary value providing the data to a set of one or more end user consumer devices for consumers correlated to the monetary value.

2. The method of claim 1, wherein providing the data to a set of one or more end user consumer devices for consumers correlated to the monetary value comprises providing data to end user consumer devices according to a service level agreements with end users.

3. The method of claim 1, wherein providing the data to a set of one or more end user consumer devices for consumers correlated to the monetary value comprises providing data to different end user consumer devices according different tiering levels.

4. The method of claim 1, wherein providing the data to a set of one or more end user consumer devices for consumers correlated to the monetary value comprises gating the data to intentionally delay delivery of the data.

5. The method of claim 1, wherein providing the data to a set of one or more end user consumer devices for consumers correlated to the monetary value comprises providing data to an end user consumer device based on an amount paid by a subscriber.

6. The method of claim 1, wherein providing the data to a set of one or more end user consumer devices for consumers correlated to the monetary value comprises providing data by selecting an infrastructure from among a plurality of infrastructures to deliver the data to one or more end user consumer devices, wherein selecting an infrastructure is performed to select a preferred infrastructure for preferred subscribers.

7. The method of claim 1 further comprising, providing statistics about how data was provided to end user consumer devices to a data provider.

8. In a computing system, a method of delivering data, the method comprising:
determining a consumer tier for a consumers of data; and
aging data before providing the data to end user devices correlated to the consumer tier to match the consumer tier.

9. The method of claim 8, wherein aging data comprises aging data for end user consumer devices according to service level agreements with end users.

10. The method of claim 8, wherein aging data comprises aging data for different end user consumer devices according different tiering levels.

11. The method of claim 8, wherein aging data comprises gating the data to intentionally delay delivery of the data.

12. The method of claim 8, wherein aging data comprises aging data for an end user consumer device based on an amount paid by a subscriber.

13. The method of claim 8, wherein aging data comprises selecting an infrastructure from among a plurality of infrastructures to deliver the data to one or more end user consumer devices, wherein selecting an infrastructure is performed to select a preferred infrastructure for preferred subscribers and a less preferred infrastructure for less preferred subscribers.

14. The method of claim 8 further comprising, providing statistics about how data was provided to end user consumer devices to a data provider.

15. A computing system for delivering data, the computing system comprising:
an event data market, wherein the event data market is configured to:
receive data from a data provider;
determine the data's value as a function of time;
determine consumers' service level for receiving data; and
send the data to end user devices correlated to consumers, wherein sending is performed based on the data's value as a function of time and a consumer's service level for receiving data.

16. The system of claim 15, wherein sending data comprises aging data for end user consumer devices according to service level agreements with end users.

17. The system of claim 15, wherein sending data comprises gating the data to intentionally delay delivery of the data.

18. The system of claim 15, wherein sending data comprises aging data for an end user consumer device based on an amount paid by a subscriber.

19. The system of claim 15, wherein sending data comprises selecting an infrastructure from among a plurality of infrastructures to deliver the data to one or more end user consumer devices, wherein selecting an infrastructure is performed to select a preferred infrastructure for preferred subscribers and a less preferred infrastructure for less preferred subscribers.

20. The system of claim 15, wherein the event data market is further configured to provide statistics about how data was provided to end user consumer devices to the data provider.
